(19) United States
(12) Patent Application Publication
(10) Pub. No.: US 2016/0312757 A1
(43) Pub. Date: Oct. 27, 2016

(54) IGNITION SYSTEM AND METHOD FOR OPERATING AN IGNITION SYSTEM

(71) Applicant: ROBERT BOSCH GMBH, Stuttgart (DE)

(72) Inventors: Tim Skowronek, Missen-Wilhams (DE); Thomas Pawlak, Immenstadt (DE); Wolfgang Sinz, Hergatz (DE)

(21) Appl. No.: 15/032,779

(22) PCT Filed: Oct. 16, 2014
(86) PCT No.: PCT/EP2014/072230

§ 371 Date: Jul. 11, 2016

(30) Foreign Application Priority Data
Nov. 14, 2013 (DE) 102013223224.1
Aug. 13, 2014 (DE) 102014216030.8

(51) Int. Cl. F02P 9/00; F02P 17/12

(52) U.S. Cl. CPC F02P 9/007; F02P 17/12

(57) ABSTRACT

A method for operating an ignition system for an internal combustion engine is described, including a boost converter, characterized by a detection of a spark breakaway and, in response thereto, a modification of the operating mode of the boost converter. An ignition system for an internal combustion engine is also described, including a boost converter, which includes an arrangement for carrying out the aforementioned method.

### FIELD OF THEN INVENTION

The present invention relates to a method for operating an ignition system for an internal combustion engine. In addition, the present invention relates to a corresponding ignition system. The present invention relates, in particular, to an avoidance of unstable operating states of such an ignition system.

### BACKGROUND INFORMATION

Ignition systems are known in the related art for spark-igniting ignitable mixtures in combustion chambers of internal combustion engines. A spark gap within the combustion chamber is acted on with such a voltage that a spark discharge takes place, which ignites the mixture. The main requirements of modern ignition systems are an indirect result of necessary emission and fuel reductions. Requirements of ignition systems and their spark (energies) are derived from corresponding engine-related approaches such as supercharging and lean operation and shift operation (spray-guided direct injection) in combination with increased exhaust gas recirculation rates (EGR). The representation of increased ignition voltage requirements and energy requirements in conjunction with increased temperature requirements is necessary. In conventional inductive ignition systems, the entire energy required for ignition must be temporarily stored in the ignition coil. The stringent requirements with respect to energy requirement result in a large ignition coil design. This conflicts with the reduced installation space conditions of modern engine concepts (“downsizing”). One application of the applicant describes an ignition system in which two main functions of the ignition system are assumed by different assembly units. A first voltage generator (“primary voltage generator”) generates a high voltage for a high voltage breakdown at the spark gap. Energy for igniting the mixture is subsequently delivered to the spark via a bypass (for example, including a boost converter). The boost converter in this case enables a controllable energy characteristic and spark characteristic in wide ranges. It is an object of the present invention to secure the use of a boost converter in an ignition system against unforeseen operating states.

### SUMMARY OF THE INVENTION

The aforementioned object is achieved according to the present invention by a method for operating an ignition system for an internal combustion engine, including a boost converter. The present invention in this case provides for detecting a spark breakaway prior to or during the use of the boost converter and modifying the operating mode of the boost converter in response thereto. In other words, it is checked whether a spark breakaway has taken place and if a spark breakaway has occurred, the voltage generated at the boost converter is modified. Since the output voltage of the boost converter increases as a result of a spark breakaway, the output voltage of the boost converter in the case of ideal components without protective circuitry would increase to the point of the boost converter self-destructing. The above described scenario is avoided by suitably modifying the operating mode of the boost converter, for example, by switching off or reducing the generation of an output voltage of the boost converter.

The further descriptions herein show further refinements of the present invention.

The modification of the operating mode of the boost converter may further include a switching off of the voltage generated by the boost converter. In other words, the voltage generated by the boost converter is switched off when a spark breakaway is detected, as a result of which the component load is significantly reduced.

The spark breakaway may further take place at an earlier point in time—compared to a proper ignition process. In other words, the spark breakaway is understood to be a premature, unforeseen breakaway of the ignition spark, which occurs at an earlier point in time than in the case of a regularly occurring ignition process. A proper ignition process is characterized in that the ignition causes a conductive spark and the spark causes a mixture to ignite. The point in time of the spark breakaway may be detected across time, across the crank angle or across another suitable parameter.

In one refinement, the method may also include a measurement of a spark current in a loop of the spark gap. In other words, a current is measured, which allows a conclusion to be drawn about a potential breakaway of the ignition spark. The spark breakaway is detected in response to an undercutting of a threshold value of the spark current. In this case, a predefined current value may be stored as a reference and retrieved in order to compare the measured value with the reference. The current measurement may be relatively precisely and cost-effectively carried out through mediation of hardware already included in ignition systems, so that the present invention may be implemented in a particularly cost-effective manner. Alternatively, a conclusion may be drawn about the level of the spark current via a voltage measurement. A defined output is delivered by the operation of the boost converter. Thus, current and voltage are in a fixed relationship to one another.

The spark current may be further measured via a shunt, which is located in a loop with a spark gap of the ignition system. The shunt in this case may also be used to ascertain a control variable for the operating mode of the boost converter (for example, its frequency). The measurement with the aid of the shunt traces the current measurement back to a voltage measurement, so that a reference for ascertaining a spark breakaway may also be stored as a voltage value and provide the basis of a comparison. Electrical circuitry or analog circuits or microcontroller or ASICs frequently found in ignition systems may represent a cost-effective option for ascertaining a voltage with sufficient accuracy. This enables a cost-effective implementation of the present invention.

According to one advantageous exemplary embodiment, the detection of a spark breakaway includes the following steps: a current of an ignition spark and/or a voltage characterizing a current of the ignition spark is measured in a first step. In a second step, it is ascertained whether an undercut condition is met by checking whether the current falls below a threshold value. Alternatively or in addition, it is ascertained whether an exceedance condition is met by checking whether the voltage characterizing the current of the ignition spark exceeds a threshold value. In addition, it is ascertained whether a minimum time condition is met by checking whether the current falls below the threshold value for a predetermined minimum period or whether the voltage characterizing the current of the ignition spark exceeds the threshold value for a predetermined minimum period.

According to the advantageous exemplary embodiment, the modification of the operating mode of the boost converter includes the step of reducing or switching off the voltage generation of the boost converter if the minimum time condition and the undercut condition and/or exceedance condition is/are met.

The ignition system for an internal combustion engine, with which the method according to the present invention is carried out, includes a boost converter. The ignition system includes an arrangement for detecting a spark breakaway and an arrangement for modifying the operating mode of the boost converter in response to a detected spark breakaway. In other words, the ignition system for a spark-ignited internal combustion engine is configured to adjust the operating mode of a boost converter contained therein by using the method according to the present invention, as it has been described above as the first-mentioned inventive aspect.

The modification of the operating mode of the boost converter may include switching off the boost converter or at least reducing its output, as a result of which the voltage generation within the boost converter is reduced or comes to a stop and the boost converter assumes a stable state.

The ignition system may be configured to detect the point in time of the spark breakaway as premature compared to a point in time of a spark breakaway after a properly occurring ignition process. In other words, the ignition system is able to ascertain the point in time of the spark breakaway across time, across the crank angle, compared to the ignition timing or the like, and to compare it with a reference in terms of whether a continuous operation of the boost converter in view of the point in time of an instantaneous spark breakaway is safety-critical or not. In the event the point in time of the spark breakaway could impair the safety of the operation of the boost converter, the ignition system generates a control signal, with the aid of which the boost converter is transferred to a secure state and switched off.

The ignition system may further include an arrangement for measuring a spark current or a corresponding voltage, via which a breakaway of the ignition spark may be detected. This may include, for example, a shunt in a loop with the ignition spark gap. In addition or alternatively, it is possible to use electrical circuitry or analog circuits or microcontrollers or ASICs already frequently found in ignition systems for cost-effectively ascertaining a voltage with sufficient accuracy. This enables a cost-effective implementation of the present invention. The features, feature combinations, scenarios and the associated advantages result from the ignition system corresponding to the method according to the present invention, so that to avoid repetitions, reference is made to the foregoing statements.

Exemplary embodiments of the present invention are described in detail below with reference to the accompanying drawings.

### BRIEF DESCRIPTION OF THE DRAWINGS

FIG. 1 shows a circuit diagram of one exemplary embodiment of an ignition system according to the present invention.

FIG. 2 shows representations of current-time diagrams and associated switching sequences for the circuit shown in FIG. 1.

FIG. 3 shows time diagrams for illustrating electrical variables within the ignition system in connection with a breakaway of an ignition spark.

FIG. 4 shows a step diagram, illustrating steps of one exemplary embodiment of a method according to the present invention.

### DETAILED DESCRIPTION

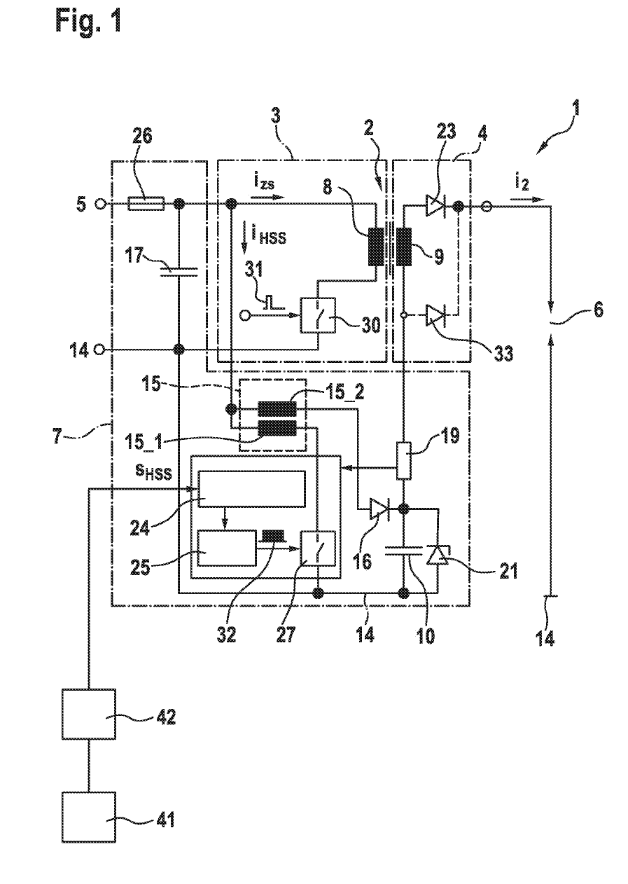

FIG. 1 shows a circuit of an ignition system 1, which includes a step-up transformer 2 as a high voltage generator, the primary side 3 of which may be supplied with electrical energy from an electrical energy source 5 via a first switch 30. Step-up transformer 2 includes, for example, a primary coil 8 and a secondary coil 9. A fuse 26 is provided at the input of the circuit, in other words, therefore, at the terminal to electrical energy source 5. In addition, a capacitance 17 for stabilizing the input voltage is provided in parallel to the input of the circuit or in parallel to electrical energy source 5. Secondary side 4 of step-up transformer 2 is supplied with electrical energy via an inductive coupling of primary coil 8 and secondary coil 9, and includes a diode 23 known from the related art for suppressing the powering spark, this diode 23 being alternatively substitutable with diode 21. A spark gap 6, via which ignition current i₂ is intended to ignite the combustible gas mixture, is provide in a loop with secondary coil 9 and diode 23 against an electrical ground 14. A boost converter 7 is provided between electrical energy source 5 and secondary side 4 of step-up transformer 2. Boost converter 7 includes, for example, an inductance 15, a switch 27, a capacitance 10 and a diode 16. In boost converter 7, inductance 15 is provided in the form of a transformer having a primary side 15_1 and a secondary side 15_2. Inductance 15 in this case serves as an energy store for maintaining a current flow. Two first terminals of primary side 15_1 and secondary side 15_2 of the transformer are each connected to electrical energy source 5 and fuse 26. In this configuration, a second terminal of primary side 15_1 is connected via switch 27 to electrical ground 14. A second terminal of secondary side 15_2 of the transformer is connected without a switch directly to diode 16 which, in turn, is connected via a node to a terminal of capacitance 10. This terminal of capacitance 10 is connected, for example, via a shunt 19 to secondary coil 9 and another terminal of capacitance 10 is connected to electrical ground 14. The power output of the boost converter is fed via the node at diode 16 into the ignition system and provided to spark gap 6.

Diode 16 is oriented conductively in the direction of capacitance 10. Due to the transfer ratio, a switching operation by switch 27 in the branch of primary side 15_1 also acts on secondary side 15_2. However, since current and voltage according to the transformation ratio are higher or lower on the one side than on the other side of the transformer, more favorable dimensionings for switch 27 for switching operations may be found. For example, lower switching voltages may be implemented, as a result of which the dimensioning of switch 27 is potentially simpler and more cost-effective. Switch 27 is controlled via a control 24, which is connected via a driver 25 to switch 27. Shunt 19 is provided as a current measuring arrangement or voltage measuring arrangement between capacitance 10 and secondary coil 9, the measuring signal of which is fed to switch 27. In this way, switch 27 is configured to react to a defined range of current intensity i₂ through secondary coil 9. A Zener diode 21 is connected in the reverse direction in parallel to capacitance 10 for securing capacitance 10. Furthermore, control 24 receives a control signal S_{HSS}. Via this signal, the feed of energy or power output via bypass 7 into the secondary side may be switched on and off. In the process, the output of the electrical variable introduced by the boost converter and into the spark gap, in particular via the frequency and/or pulse-pause ratio, may also be controlled via a suitable control signal S_{HSS}. A switching signal 32 is also indicated, with the aid of which switch 27 may be activated via driver 25. When switch 27 is closed, inductance 15 is supplied with a current via electrical energy source 5, which flows directly to electrical ground 14 when switch 27 is closed. When switch 27 is open, the current is directed through inductance 15 via diode 16 to capacitor 10. The voltage occurring in response to the current in capacitor 10 is added to the voltage dropping across second coil 9 of step-up transformer 2, thereby supporting the electric arc at spark gap 6. In the process, however, capacitor 10 is discharged, so that by closing switch 27, energy may be brought into the magnetic field of inductance 15, in order to charge capacitor 10 with this energy again when switch 27 is re-opened. It is apparent that control 31 of switch 30 provided in primary side 3 is kept significantly shorter than is the case for switch 27. Optionally, a non-linear two-terminal circuit, symbolized in the following by a high voltage diode 33 of coil 9 of boost converter 7 on the secondary side, may be connected in parallel. This high voltage diode 33 bridges high voltage generator 2 on the secondary side, as a result of which the energy delivered by boost converter 7 is guided directly to spark gap 6, without being guided through secondary coil 9 of high voltage generator 2. No losses across secondary coil 9 occur as a result and the degree of efficiency is increased. A dependency according to the present invention of the operating mode of the boost converter from the existence or premature termination of the ignition spark is possible with a microcontroller 42, which is configured to ascertain the point in time of termination as a function of a crank angle. Microcontroller 42 is further connected to a memory 41, from which limits for spark current ranges and references (parameters) assigned to these spark current ranges for a corresponding operating mode of the control signal may be read out. Microcontroller 42 is configured to influence the operating mode of the boost converter, to supply control 24 with a spark current-dependent modified control signal S_{HSS}, in response to which driver 25 supplies switch 27 with a changed switching signal 32. For example, the generation of energy may be prematurely interrupted with the aid of the boost converter in the event of a spark breakaway. A modification according to the present invention of the operating mode of the boost converter may take place in a different way and for different purposes. Individual options (with no assertion to being exhaustive) are cited below:

Option 1: The boost converter may be switched off if the spark current falls below a predefined threshold value for a specific period of time.

Option 2: The operating mode of the boost converter is changed independently of the crank angle only via the detection of a threshold value, which correlates with the spark breakaway.

Option 3: The operating mode of the boost converter is changed independently of the crank angle only via the detection of a threshold value, taking a delay time into consideration, which correlates with the spark breakaway to be expected.

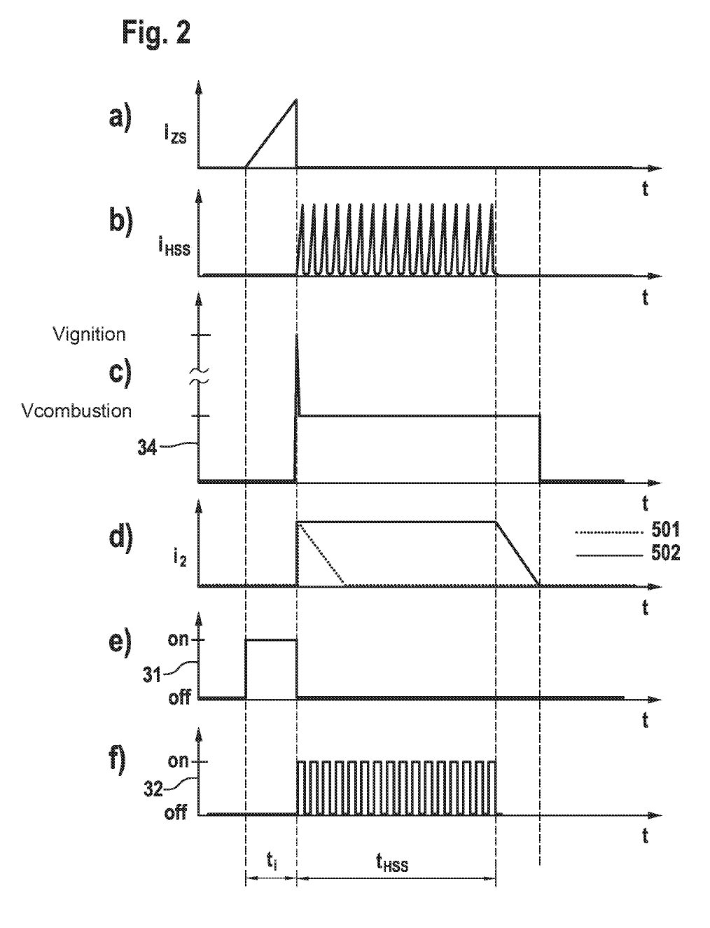

FIG. 2 shows time diagrams for a) ignition coil current i_{zs}, b), associated boost converter current i_{HSS}, c), the voltage on the output side across spark gap 6, d) secondary coil current i₂ for the ignition system depicted in FIG. 1 without (501) and with (502) the use of boost converter 7, e) switching signal 31 of switch 30 and f) switching signal 32 of switch 27. In particular: Diagram a) shows a short and steep rise in primary coil current i_{zs}, which occurs during the time in which switch 30 is in the conductive state (“ON,” see diagram 3e). With switch 30 switched off, primary coil current i_{zs} also drops to 0 A. Diagram b) illustrates in addition the current consumption of boost converter 7 according to the present invention, which takes place as a result of a pulsed activation of switch 27. In practice, clock rates in the range of several 10 kHz have proven to be a reliable switching frequency, in order to achieve corresponding voltages on the one hand and acceptable degrees of efficiency on the other hand. The integral multiples of 10,000 Hz in the range of between 10 kHz and 100 kHz are cited by way of example as possible range limits. To regulate the output delivered to the spark gap, a, in particular, stepless control of the pulse-pause ratio of signal 32 is recommended for generating a corresponding output signal. Diagram c) shows profile 34 of the voltage occurring at spark gap 6 during the operation according to the present invention. Diagram d) shows the profiles of secondary coil current i₂. Once primary coil current i_{zs} results in 0 A due to an opening of switch 30 and the magnetic energy stored in the step-up transformer is discharged as a result in the form of an electrical arc across spark gap 6, a secondary coil current i₂ occurs, which rapidly drops toward 0 without boost converter (501). In contrast to this, an essentially constant secondary coil current i₂ (502) is driven across spark gap 6 by a pulsed activation (see diagram f, switching signal 32) of switch 27, secondary current i₂ being a function of the burning voltage at spark gap 6 and, for the sake of simplicity, a constant burning voltage being assumed here. Only after interruption of boost converter 7 by opening switch 27, does secondary coil current i₂ then also drop toward 0 A. It is apparent from diagram d) that the descending flank is delayed by the use of boost converter 7. The entire period of time during which the boost converter is used, is characterized as t_{HSS} and the period of time during which energy is passed into step-up transformer 2 on the primary side, as tᵢ. The starting time of t_{HSS} as opposed to tᵢ may be variably selected. In addition, it is also possible to increase the voltage supplied by the electrical energy source via an additional DC-DC converter (not depicted), before this voltage is further processed in boost converter 7 according to the present invention. It is noted that specific designs are a function of many external boundary conditions inherent to circuitry. The involved person skilled in the art is not presented with any unreasonable difficulties in undertaking the dimensionings suitable for this purpose and for the boundary conditions that must be taken into consideration.

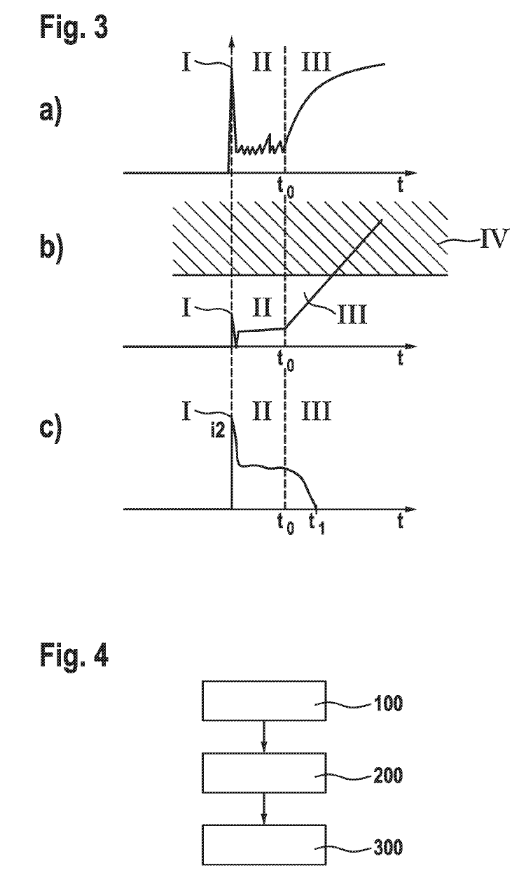

The upper partial diagram a) in FIG. 3 shows the output voltage of the ignition system (i.e., the voltage at spark gap 6), across time t. In a first time range 1, a high voltage peak is apparent, through which the ignition spark materializes. The breakdown of the ignition spark gap 6 is then followed by a time range II, in which the voltage takes on significantly lower values than in time range I. In this range, the voltage is, in particular, a function of the ratios in the range of spark gap 6, which are determined by the turbulence ratios and pressure ratios in the combustion chamber, as well as the electrode geometry of the spark plug. At a point in time t₀, a third time range III begins. Since the ignition spark becomes increasingly unstable at point in time t₀, the voltage increases sharply in time range III. A discharge of the voltage present across spark gap 6 cannot occur in boost converter 7, since the conductivity of the mixture in spark gap 6 has sharply decreased after the spark breakaway.

Partial diagram b) shows the output voltage at boost converter 7, which is at a constant low value in a time range II. In time range III, the output voltage of boost converter 7 increases sharply due to the spark deflection. Not until time range IV after t1 does the spark break away and the voltage at boost converter 7 continues to increase. Because the electrical energy converted by boost converter 7 cannot be transferred to spark gap 6, the output voltage increases until it reaches an unstable range IV, in which the electrical load of the components of boost converter 7 increases sharply, and their stability is jeopardized.

Partial diagram c) shows spark current i2 across time. Spark current i2 exhibits a peak during breakdown of the spark gap at point in time I. In the following time range II, spark current i2 remains at a middle, essentially constant level. Due to turbulence at the end of time range II, the resistance for spark current i2 increases after a point in time t₀, so that in a subsequent time range III, spark current i2 decreases sharply and ultimately stops at point in time t₁. According to the present invention, the decrease of spark current i2 or its complete stop may be detected as a spark breakaway. In response to this detection, the method according to the present invention is able to modify the operating mode of the boost converter, in order either to prompt the boost converter to reduce its energy consumption or to counteract a decrease of the spark current with the aid of the boost converter to avoid a spark breakaway.

FIG. 4 shows a flow chart, illustrating the steps of one exemplary embodiment of a method according to the present invention. A spark current i2 is measured in step 100 and, in response to an undercutting of a threshold value for spark current i2, a spark breakaway is detected in step 200. In response to a detection of the spark breakaway, the boost converter is switched off in step 300, and if necessary, delayed by a delay time. In this way, it is possible to avoid an increase of the output voltage at the boost converter in an unstable range IV or in a range above the load capacity limit. The components of the boost converter remain undamaged as a result.

According to one exemplary embodiment, current i2 of an ignition spark and/or a voltage characterizing current i2 of the ignition spark is measured in step 100. It is also ascertained in step 100 whether an undercut condition is met, by checking whether current i2 falls below a first threshold value. If current i2 falls below the first threshold value, the undercut condition is met. Alternatively or in addition, it is ascertained whether an exceedance condition is met, by checking whether the voltage characterizing current i2 of the ignition spark exceeds a second threshold. If the voltage characterizing current i2 of the ignition current exceeds the second threshold, the exceedance threshold is met. It is also checked in step 100 whether the current falls below the first threshold value for a predetermined minimum period of time or whether the voltage characterizing the current of the ignition spark exceeds the second threshold value for a predetermined minimum period of time. A minimum time condition is met if one of the two cases is met. If the minimum time condition and the undercut and/or exceedance condition are met, the voltage generation of the boost converter is reduced or switched off in step 300. To switch off the boost converter, switch 27 is opened and no longer clocked. When operating the boost converter, switch 27 is switched on and off cyclically. To reduce the voltage generation, the pulse duty factor or the frequency with which switch 27 is cyclically switched is reduced.

A computer program may be provided, which is configured to carry out all described steps of the method according to the present invention. The computer program in this case is stored on a memory medium. As an alternative to the computer program, the method according to the present invention may be controlled by an electrical circuit provided in the ignition system, an analog circuit, an ASIC or a microcontroller, which is configured to carry out all described steps of the method according to the present invention.

Even though the aspects and advantageous specific embodiments according to the present invention have been described in detail with reference to exemplary embodiments explained in conjunction with the appended drawing figures, modifications and combinations of features of the depicted exemplary embodiments are possible for those skilled in the art, without departing from the scope of the present invention, the scope of protection of which is defined by the claimed subject matter.

1-10. (canceled)

11. A method for operating an ignition system for an internal combustion engine having a boost converter, the method comprising:
detecting a spark breakaway, and in response thereto; and
modifying an operating mode of the boost converter.

12. The method of claim 11, wherein the modifying of the operating mode includes reducing a voltage generation of the boost converter.

13. The method of claim 11, wherein the modifying of the operating mode includes switching off a voltage generation of the boost converter.

14. The method of claim 11, further comprising:
measuring a spark current and/or a corresponding measuring voltage; and
detecting, in response to an undercutting of a threshold value of the spark current or a threshold value of a corresponding voltage, the spark breakaway.

15. The method of claim 14, wherein the measurement of the spark current or of a corresponding measuring voltage occurs via a shunt, which is located in a loop with a spark gap of the ignition system.

16. The method of claim 11, wherein the detection of a spark breakaway includes the following:
measuring a current of an ignition spark and/or a voltage characterizing the current of the ignition spark;
ascertaining whether an undercut condition is met, by ascertaining whether the current falls below a first threshold value or the voltage characterizing the current of the ignition spark exceeds a second threshold value; and
ascertaining whether a minimum time condition is met, by ascertaining whether the current falls below the first threshold value for a predetermined minimum period of time or whether the voltage characterizing the current of the ignition spark exceeds the second threshold value for a predetermined minimum period of time.

17. The method of claim 11, wherein the modifying of the operating mode of the boost converter includes reducing or switching off the voltage generation of the boost converter if the minimum time condition and the undercut and/or exceedance condition is met.

18. A computer readable medium having a computer program, which is executable by a processor, comprising:
a program code arrangement having program code for operating an ignition system for an internal combustion engine having a boost converter, by performing the following:
detecting a spark breakaway, and in response thereto; and
modifying an operating mode of the boost converter.

19. The computer readable medium of claim 18, further comprising:
measuring a spark current and/or a corresponding measuring voltage; and
detecting, in response to an undercutting of a threshold value of the spark current or a threshold value of a corresponding voltage, the spark breakaway.

10. An ignition system, comprising:
a processor which is configured for operating an ignition system for an internal combustion engine having a boost converter, by performing the following:
detecting a spark breakaway, and in response thereto; and
modifying an operating mode of the boost converter.
